(19) United States
(12) Patent Application Publication
(10) Pub. No.: US 2026/0326472 A1
(43) Pub. Date: Oct. 22, 2026

(54) Foldable Greeting Cards with Progressing Images

(71) Applicants: Saleel Limaye, Fairview, TX (US); Shibani Kagal, Fairview, TX (US)

(72) Inventors: Saleel Limaye, Fairview, TX (US); Shibani Kagal, Fairview, TX (US)

(21) Appl. No.: 19/326,341

(22) Filed: Sep. 11, 2025

Related U.S. Application Data
(60) Provisional application No. 63/789,611, filed on Apr. 16, 2025.

(51) Int. Cl. B42D 15/04

(52) U.S. Cl. CPC B42D 15/042

(57) ABSTRACT

Examples of foldable greeting cards are described. In one aspect, a foldable greeting card includes a front panel and a back panel. The front panel includes a first portion and a second portion of a first image. The back panel includes a third portion of the first image that corresponds to the second portion of the first image. In an unfolded configuration of the greeting card, the first portion and the second portion of the first image form a first representation of the first image. In a first folded configuration of the greeting card, the first portion of the first image and the third portion of the first image form a second representation of the first image. The first representation of the first image and the second representation of the first image convey a same visual content.

### RELATED APPLICATIONS

This application claims the benefit of U.S. Provisional Patent Application No. 63/789,611, filed on Apr. 16, 2025, which is incorporated by reference herein in its entirety.

### TECHNICAL FIELD

The following generally relates to printed media structures, and in particular, to foldable greeting cards with progressing visual content.

### BACKGROUND

Greeting cards are commonly used to express sentiments for occasions such as birthdays, holidays, achievements, and condolences. These cards vary in form, from simple single-fold designs to more complex formats with multiple folds, pop-up elements, or three-dimensional features. Some greeting cards attempt to tell a story, typically using a book-style format. However, these often rely on conventional page-turning structures and may be bulky or costly to produce due to their multi-page construction.

### SUMMARY

The present disclosure describes foldable greeting cards and foldable printed articles.

In a general aspect, a foldable greeting card comprises a front panel and a back panel. The front panel comprises a first portion and a second portion of a first image. The back panel comprises a third portion of the first image that corresponds to the second portion of the first image. In an unfolded configuration of the greeting card, the first portion and the second portion of the first image on the front panel form a first representation of the first image and are visible at a first perspective, and the third portion of the first image on the back panel is concealed at the first perspective. In a first folded configuration of the greeting card, the first portion of the first image on the front panel and the third portion of the first image on the back panel form a second representation of the first image and are visible at the first perspective, and the second portion of the first image on the front panel is concealed at the first perspective. The first representation of the first image and the second representation of the first image convey a same visual content.

Particular implementations may include one or more of the following features.

In some implementations, the front panel further comprises a first portion and a second portion of a second image, and the back panel comprises a third portion of the second image that corresponds to the second portion of the second image. In the unfolded configuration of the greeting card, the first portion and the second portion of the second image on the front panel form a first representation of the second image and are visible at the first perspective, and the third portion of the second image on the back panel is concealed at the first perspective. In a second folded configuration of the greeting card, the first portion of the second image on the front panel and the third potion of the second image on the back panel form a second representation of the second image and are visible at the first perspective, the second portion of the second image on the front panel is concealed at the first perspective, and the first representation of the second image and the second representation of the second image convey a same visual content. In the second folded configuration of the greeting card, the first portion and the second portion of the first image on the front panel form the first representation of the first image and are visible at the first perspective, and the third portion of the first image on the back panel is concealed at the first perspective.

In some implementations, the second portion of the first image and third portion of the first image are duplicates of each other, and the second portion of the first image and third portion of the second image are duplicates of each other.

In some implementations, the front panel further comprises a first portion and a second portion of a third image. In the unfolded configuration of the greeting card, the first portion and the second portion of the third image on the front panel form a representation of the third image and are visible at the first perspective. In either the first folded configuration or the second folded configuration, the first portion and the second portion of the third image on the front panel are concealed at the first perspective.

In some implementations, a visible area of the greeting card in the unfolded configuration at the first perspective is larger than a visible area of the greeting card in the second folded configuration at the first perspective, and the visible area of the greeting card in the second folded configuration at the first perspective is larger than a visible area of the greeting card in the first folded configuration at the first perspective.

In some implementations, the first image, the second image, and the third image collectively represent a narrative sequence.

In some implementations, the first image, the second image, and the third image are associated with a message, a celebration, or an event.

In some implementations, the foldable greeting card is made of a cardstock, a laminated paper, or a printable plastic.

In another aspect, a foldable greeting card comprises a front panel and a back panel. The front panel comprises a first portion and a second portion of a first image, and the back panel comprises a third portion of the first image that corresponds to the second portion of the first image. In an unfolded configuration of the greeting card, the first portion and the second portion of the first image on the front panel form a first representation of the first image and are visible at a first perspective, and the third portion of the first image on the back panel is concealed at the first perspective. In a first folded configuration of the greeting card, the first portion of the first image on the front panel and the third portion of the first image on the back panel form a second representation of the first image and are visible at the first perspective, and the second portion of the first image on the front panel is concealed at the first perspective, and the first representation of the first image and the second representation of the first image convey a same visual content.

The front panel further comprises a first portion and a second portion of a second image, and the back panel comprises a third portion of the second image that corresponds to the second portion of the second image. In the unfolded configuration of the greeting card, the first portion and the second portion of the second image on the front panel form a first representation of the second image and are visible at the first perspective, and the third portion of the second image on the back panel is concealed at the first perspective. In a second folded configuration of the greeting card, the first portion of the second image on the front panel and the third potion of the second image on the back panel form a second representation of the second image and are visible at the first perspective, the second portion of the second image on the front panel is concealed at the first perspective, and the first representation of the second image and the second representation of the second image convey a same visual content. In the second folded configuration of the greeting card, the first portion and the second portion of the first image on the front panel form the first representation of the first image and are visible at the first perspective, and the third portion of the first image on the back panel is concealed at the first perspective.

The front panel further comprises a first portion and a second portion of a third image. In the unfolded configuration of the greeting card, the first portion and the second portion of the third image on the front panel form a representation of the third image and are visible at the first perspective. In either the first folded configuration or the second folded configuration, the first portion and the second portion of the third image on the front panel are concealed at the first perspective.

Particular implementations may include one or more of the following features.

In some implementations, the second portion of the first image and third portion of the first image are duplicates of each other, and the second portion of the first image and third portion of the second image are duplicates of each other.

In some implementations, a visible area of the greeting card in the unfolded configuration at the first perspective is larger than a visible area of the greeting card in the second folded configuration at the first perspective, and the visible area of the greeting card in the second folded configuration at the first perspective is larger than a visible area of the greeting card in the first folded configuration at the first perspective.

In some implementations, the first image, the second image, and the third image collectively represent a narrative sequence.

In some implementations, the first image, the second image, and the third image are associated with a message, a celebration, or an event.

In some implementations, the foldable greeting card is made of a cardstock, a laminated paper, or a printable plastic.

In yet another aspect, a foldable printed article comprises a substrate comprising a first surface and a second surface, and a visual composition printed on the substrate. The visual composition comprises a plurality of image components printed on the first surface and the second surface. The substrate is foldable between an unfolded configuration and a folded configuration. In the unfolded configuration, a first set of the plurality of image components are visible from a viewing perspective and collectively form a first representation of the visual composition, and a second set of the plurality of image components are concealed from the viewing perspective. In the folded configuration, at least a portion of the first set and at least a portion of the second set are visible and collectively form a second representation of the visual composition. The first representation and the second representation convey a same visual content.

Particular implementations may include one or more of the following features.

In some implementations, the plurality of visual components form a sequential narrative across the unfolded configuration and the folded configuration.

In some implementations, the substrate comprises at least one dividing line, and wherein the substrate is foldable along the at least one dividing line.

In some implementations, at least two image components are printed on opposing sides of the at least one dividing line and visually combine to form a continuous image in the unfolded configuration.

In some implementations, at least one image component printed on the first surface and at least one image component printed on the second surface visually align to form a continuous image in the folded configuration.

In some implementations, the substrate comprises a paper material or a printable polymer material.

### BRIEF DESCRIPTION OF THE DRAWINGS

FIG. 1 is a schematic front view of an example of a greeting card with a card stock sheet of the greeting card in an unfolded configuration, according to one or more implementations of the present disclosure.

FIG. 2A is a schematic side view of the greeting card of FIG. 1 with the card stock sheet of the greeting card in an unfolded configuration, according to one or more implementations of the present disclosure.

FIG. 2B is a schematic side view of the greeting card of FIG. 1 with the card stock sheet of the greeting card in a first folded configuration, according to one or more implementations of the present disclosure.

FIG. 2C is a schematic side view of the greeting card of FIG. 1 with the card stock sheet of the greeting card in a final folded configuration, according to one or more implementations of the present disclosure.

FIG. 3 is a schematic front view of another example of a greeting card with a card stock sheet of the greeting card in an unfolded configuration, according to one or more implementations of the present disclosure.

FIG. 4 is a schematic front view of the greeting card of FIG. 3 with the card stock sheet of the greeting card in a final folded configuration, according to one or more implementations of the present disclosure.

FIG. 5 is a schematic front view of the greeting card of FIG. 3 with the card stock sheet of the greeting card in a first folded configuration, according to one or more implementations of the present disclosure.

FIG. 6 is a schematic front view of another example of a greeting card with a card stock sheet of the greeting card in an unfolded configuration, according to one or more implementations of the present disclosure.

FIG. 7 is a schematic back side view of the greeting card of FIG. 6 with the card stock sheet of the greeting card in an unfolded configuration, according to one or more implementations of the present disclosure.

FIG. 8 is a schematic front view of the greeting card of FIG. 6 with the card stock sheet of the greeting card in a final folded configuration, according to one or more implementations of the present disclosure.

FIG. 9 is a schematic front view of the greeting card of FIG. 6 with the card stock sheet of the greeting card in a first folded configuration, according to one or more implementations of the present disclosure.

FIG. 10 is a schematic front view of another example of a greeting card with a card stock sheet of the greeting card in an unfolded configuration, according to one or more implementations of the present disclosure.

FIG. 11 is a schematic back side view of the greeting card of FIG. 10 with the card stock sheet of the greeting card in an unfolded configuration, according to one or more implementations of the present disclosure.

FIG. 12 is a schematic front view of the greeting card of FIG. 10 with the card stock sheet of the greeting card in a first folded configuration, according to one or more implementations of the present disclosure.

FIG. 13 is a schematic front view of the greeting card of FIG. 10 with the card stock sheet of the greeting card in a second folded configuration, according to one or more implementations of the present disclosure.

FIG. 14 is a schematic front view of the greeting card of FIG. 10 with the card stock sheet of the greeting card in a third folded configuration, according to one or more implementations of the present disclosure.

FIG. 15 illustrates an example process of unfolding a foldable greeting card, according to one or more implementations of the present disclosure.

Like reference numbers and designations in the various drawings indicate like elements.

### DETAILED DESCRIPTION

The present disclosure relates to a foldable greeting card configured to reveal a sequence of progressing images through a structured unfolding process. The greeting card includes multiple parts connected by fold lines, where portions of one or more images are distributed across the parts in a manner that enables partial or full visibility depending on the folded state. In some implementations, portions of an image are printed on both the front and back surfaces of the card stock sheet, such that a folded configuration allows selected image portions on opposing surfaces to visually align and form a complete or near-complete representation of an image.

Through this layered folding structure, the greeting card provides a progressive visual experience in which a fragmented image becomes whole with each unfolding step, while simultaneously introducing a new image in fragmented form. This creates a fluid narrative progression that engages the recipient. In contrast to conventional greeting cards or simple flip-style progressive cards, the foldable greeting card described herein integrates the folds as part of the image design itself, allowing transitions between visual stages to be seamless, satisfying, and visually coherent. The result is a more immersive, story-driven experience that can be customized for various occasions or narratives.

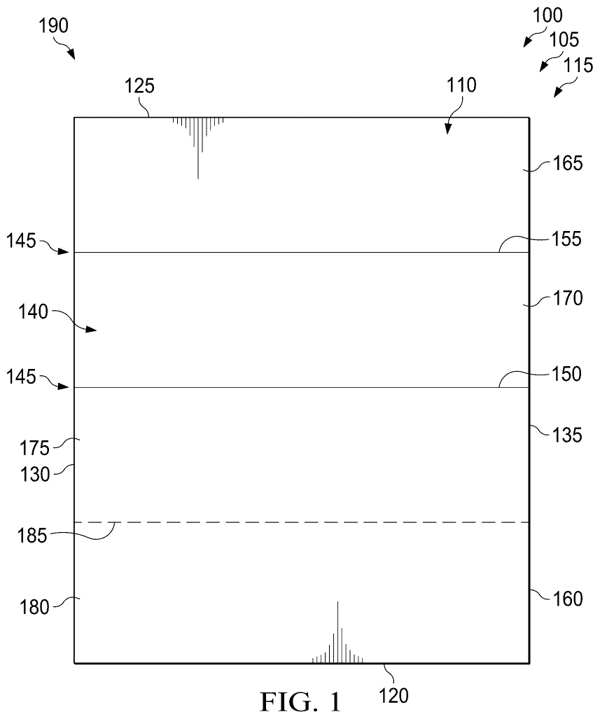

FIG. 1 is a schematic front view of an example of a greeting card 100 with a card stock sheet of the greeting card in an unfolded configuration, according to one or more implementations of the present disclosure. The greeting card 100 includes a body 105, which can be a sheet of paper or paper-like material onto which an image can be applied. The image can be applied to a surface 110 of the body 105 by printing, writing, drawing, etching, inscribing, embossing, adhering, or similar techniques. The body 105 can be formed from any material capable of supporting an image or message and capable of being folded in a manner that allows it to at least partially retain the fold, with or without assistance, and unfolded in a manner that allows it to at least partially remain unfolded, with or without assistance. The foldability can be inherent to the material or enhanced by features such as scoring, binding, or similar modifications. In the example illustrated in FIG. 1, the body 105 includes a card stock sheet 115. The term “card stock” (or “cardstock”) refers to a sheet of material that is designed to be or capable of being used as a greeting card, and is typically composed of a paper-based or paper-like material. Card stock is generally thicker and more durable than standard printer paper, but less thick and more flexible than cardboard. In some examples, card stock can have a basis weight ranging from about 65 pounds to about 130 pounds, and can be classified into categories such as lightweight (approximately 60 to 80 pounds), medium weight (approximately 80 to 110 pounds), and heavyweight (greater than approximately 110 pounds). The caliper, or thickness, of card stock is typically between about 10 points (approximately 0.010 inches) and about 16 points (approximately 0.016 inches).

As shown in FIG. 1, the card stock sheet 115 is a single sheet of material that extends from a bottom edge 120 to a top edge 125, and from a left side 130 to a right side 135. The area enclosed by the bottom 120, top 125, left side 130, and right side 135, and facing upward, defines a front surface 140 of the card stock sheet 115. At least a portion of the front surface 140 can be emblazoned with one or more images. The card stock sheet 115 includes a plurality of folds 145. The folds 145 can be either visible or invisible, scored or unscored, and bound or unbound. The width of each fold 145 can vary depending on the weight and/or caliper of the card stock material. In the example illustrated in FIG. 1, the folds 145 include a bottom fold 150 and a top fold 155. The terms “bottom,” “top,” “left,” and “right” are used herein solely to describe the relative positioning of the edges and folds based on the orientation of the greeting card 100 as shown in FIG. 1. It is understood that, depending on the orientation, the bottom 120 and bottom fold 150 can be positioned to the side or above the top 125 and top fold 155. Although FIG. 1 depicts the bottom 120, top 125, left side 130, and right side 135 as straight edges forming a rectangular shape, it is understood that the edges can include angles and/or curves, and may collectively form any geometric shape, such as a polygonal shape, a rounded shape, or a combination thereof.

The folds 145 of the card stock sheet 115 divide the front surface 140 into a plurality of panels, as illustrated in FIG. 1. For example, a bottom front panel 160 extends from the bottom fold 150 to the bottom edge 120 of the card stock sheet 115, a top front panel 165 extends from the top fold 155 to the top edge 125, and an intermediate front panel 170 extends between the bottom fold 150 and the top fold 155. The bottom front panel 160 includes a bottom front panel bottom portion 175 and a bottom front panel top portion 180, which are separated by a dividing line 185. The dividing line 185 can be either visible or invisible, as described in further detail below.

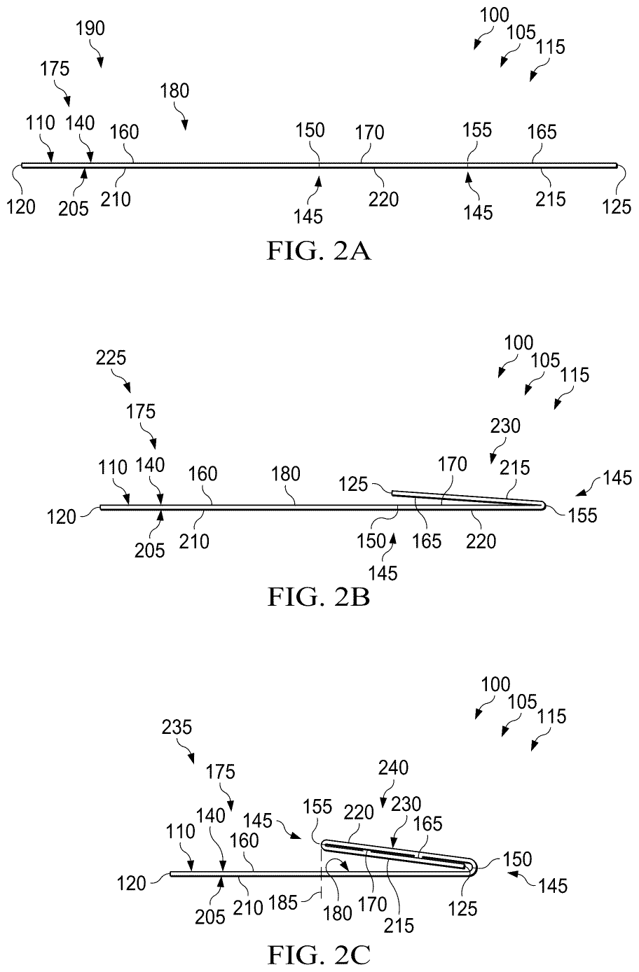

FIG. 1 illustrates the card stock sheet 115 in an unfolded configuration 190, also referred to as an open configuration. The term “unfolded configuration” refers to a state in which the folds 145 define an angle between adjacent panels greater than 90 degrees. FIG. 2A provides a right side view of the card stock sheet 115 in the unfolded configuration 190, in which the angle at each fold is approximately 180 degrees. In some examples, the card stock sheet 115 may not lie entirely flat, or not as flat as depicted in FIGS. 1 and 2A. In such cases, each of the folds 145 can retain a slight curvature due to the inherent properties of the folding structure. However, in some examples, the card stock sheet 115 can lie substantially flat, as shown, for example, during the manufacturing process or when external pressure is applied to flatten the folds. As further shown in FIG. 2A, the card stock sheet 115 of the greeting card 100 includes a back surface 205. The back surface 205 comprises a bottom back panel 210 disposed opposite the bottom front panel 160, a top back panel 215 disposed opposite the top front panel 165, and an intermediate back panel 220 disposed opposite the intermediate front panel 170.

The folding of the card stock sheet 115 of the greeting card 100 is illustrated in the right side views of FIGS. 2B and 2C. FIG. 2B depicts the card stock sheet 115 in a first folded configuration 225, in which the top fold 155 is folded. In this configuration, the top fold 155 is a forward fold, wherein the top front panel 160 is rotated forward, or in a counterclockwise direction when viewed from the right side, such that the top front panel 160 is positioned to at least partially face the intermediate front panel 170. The term “folded configuration” refers to a state in which a fold 145, such as the top fold 155 in the first folded configuration 225, defines an angle between adjacent panels of less than 90 degrees. In some examples, this angle can be less than approximately 10 degrees, such that the adjacent panels lie close to flat and are substantially parallel. The first folded configuration 225 thereby forms a first multilayered tab 230, comprising two layers of card stock. In this configuration, the top front panel 165 is obscured from a top-down view, and the top back panel 215 is oriented upward and visible when viewing the greeting card 100 from above. Additionally, the intermediate front panel 170 is at least partially—and in the example shown in FIG. 2B, substantially entirely—concealed beneath the first multilayered tab 230.

FIG. 2C illustrates the card stock sheet 115 in a final folded configuration 235. The final folded configuration 235 is achieved by folding the top fold 155 and then folding the combined structure of the top front panel 165 and the intermediate front panel 170 at the bottom fold 150, such that the top back panel 215 is positioned to face the bottom front panel 160. In this configuration, a second multilayered tab 240 is formed, comprising three or more layers of card stock, including the two layers previously formed in the first multilayered tab 230. As shown, in the final folded configuration 235, the intermediate front panel 170 is obscured from a top-down view, and the intermediate back panel 220 is oriented upward and is visible when viewing the greeting card 100 from above. Additionally, the bottom front panel 160 is at least partially concealed, as it is at least partially covered by the second multilayered tab 240. In the example illustrated in FIG. 2C, the second multilayered tab 240 covers the bottom front panel top portion 180 but does not cover the bottom front panel bottom portion 175. The lower boundary of the coverage aligns with the dividing line 185 between the bottom front panel top portion 180 and the bottom front panel bottom portion 175.

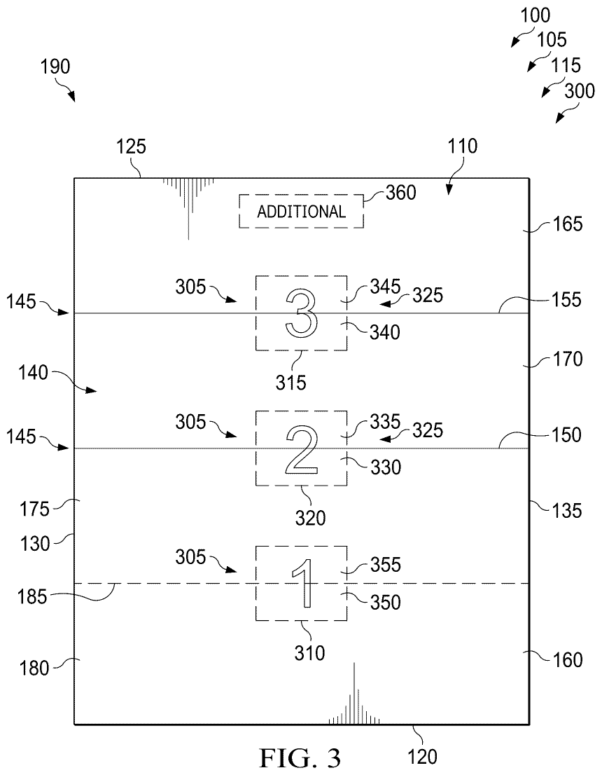

FIG. 3 is a schematic front view of another implementation of the greeting card 100, shown with the card stock sheet in an unfolded configuration, in accordance with one or more implementations of the present disclosure. The greeting card 100 of FIG. 3 is implemented as a progressing images greeting card 300 and is depicted in the unfolded configuration 190. The progressing images greeting card 300 includes a series of progressing images 305, which can include a first progressing image 310, a final progressing image 315, and an intermediate progressing image 320. The progressing images 305 can be selected to be viewed sequentially by the recipient of the progressing images greeting card 300. For example, the progressing images 305 can be arranged to convey a narrative or message, with the first progressing image 310, the intermediate progressing image 320, and the final progressing image 315 intended to be viewed in that order to represent successive stages of the narrative. The progression represented by the progressing images 305 can be based on time, location, message development, or other thematic transitions. In one example, the progressing images 305 depict a timewise sequence: the first progressing image 310 corresponds to a first time period, the intermediate progressing image 320 corresponds to a second time period occurring after the first, and the final progressing image 315 corresponds to a third time period occurring after the second. In some implementations, the sequence can follow reverse chronological order or may not be related to time at all. In one example, the progressing images 305 are discrete, separate images. In another example, the progressing images 305 can share one or more visual or thematic features.

In one example, such as the example illustrated in FIG. 3, one or more of the progressing images 305 are fold overlapping images 325. A fold overlapping image 325 includes a bottom portion located below a fold and a top portion located above the fold. In the example shown in FIG. 3, the intermediate progressing image 320 is a fold overlapping image 325 that spans the bottom fold 150. Specifically, it includes an intermediate progressing image bottom portion 330 positioned below the bottom fold 150 on the bottom front panel 160, and an intermediate progressing image top portion 335 positioned above the bottom fold 150 on the intermediate front panel 170. Similarly, the final progressing image 315 is a fold overlapping image 325 that spans the top fold 155. It includes a final progressing image bottom portion 340 located below the top fold 155 on the intermediate front panel 170, and a final progressing image top portion 345 located above the top fold 155 on the top front panel 165.

In the example illustrated in FIG. 3, the first progressing image 310 is positioned on the bottom front panel 160 and overlaps the dividing line 185 between the bottom front panel bottom portion 175 and the bottom front panel top portion 180. The first progressing image 310 includes a first progressing image bottom portion 350 located below the dividing line 185 on the bottom front panel bottom portion 175, and a first progressing image top portion 355 located above the dividing line 185 on the bottom front panel top portion 180. In some implementations, the bottom portion of an image can constitute approximately or at least approximately 10 percent, 20 percent, 30 percent, 40 percent, 50 percent, 60 percent, 70 percent, 80 percent, or 90 percent of the total image. In the example shown in FIG. 3, the bottom portion of each fold overlapping image 325 comprises from about 40 percent to about 60 percent of the image, while the top portion also comprises from about 40 percent to about 60 percent. In some implementations, one or more additional images 360 can be included. These additional images 360 can be entirely positioned within one of the following regions: the top front panel 165, the intermediate front panel 170, the bottom front panel top portion 180, and/or the bottom front panel bottom portion 175.

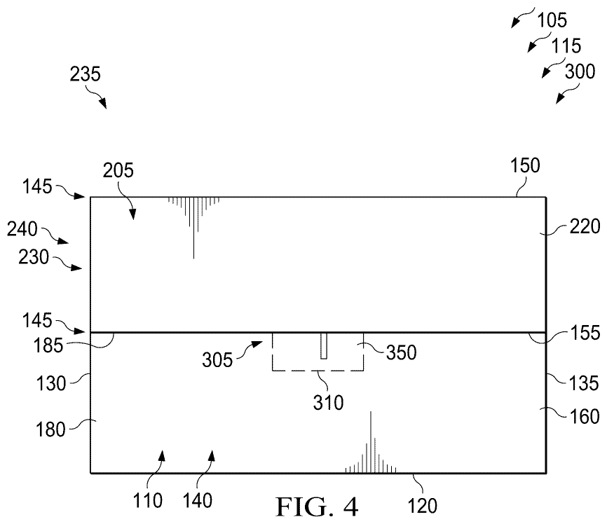

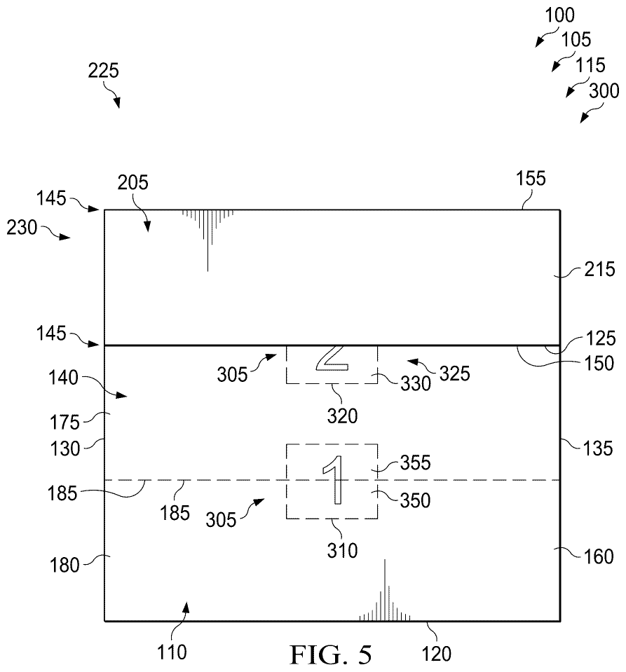

FIGS. 4 and 5 illustrate the example of the greeting card 100 of FIG. 3 in use. FIG. 4 is a schematic front view of the greeting card 100 of FIG. 3 with the card stock sheet of the greeting card in a final folded configuration 235, according to one or more implementations of the present disclosure.

In the final folded configuration 235, the greeting card 100 is initially presented to the recipient. As shown, the top fold 155 forms the first multilayered tab 230, and the bottom fold 150 forms the second multilayered tab 240. In this configuration, the bottom front panel top portion 180 is concealed beneath the second multilayered tab 240. As a result, the first progressing image top portion 355 is also obscured, and only the first progressing image bottom portion 350 remains visible to the recipient. This configuration naturally invites the recipient to lift the second multilayered tab 240—thereby unfolding the bottom fold 150—to reveal the remainder of the first progressing image 310.

FIG. 5 is a schematic front view of the greeting card 100 of FIG. 3, with the card stock sheet in the first folded configuration 235, in accordance with one or more implementations of the present disclosure. The greeting card 100 is placed in the first folded configuration 235 after the recipient unfolds the bottom fold 150. In this configuration, the recipient is able to view the entirety of the first progressing image 310. The recipient can also see the intermediate progressing image bottom portion 330, while the intermediate progressing image top portion 335 remains concealed beneath the first multilayered tab 230, which is folded at the top fold 155. This arrangement encourages the recipient to unfold the top fold 155, thereby opening the greeting card into the unfolded configuration shown in FIG. 3, in which the entire intermediate progressing image 320 is revealed. Additionally, the final progressing image 315 is also revealed in the unfolded configuration. In the example illustrated, the final progressing image 315 is implemented as a fold overlapping image 325. In some examples, the final progressing image 315 can be located entirely on the top front panel 165.

As illustrated in FIGS. 3-5, the recipient of the progressing images greeting card 100 is able to interact with the greeting card in a sequential and layered manner. With each unfolding action, a previously fragmented image becomes complete, while a new image—partially concealed across a fold—is introduced. Through successive unfolding steps, a sequence of transforming images is presented, collectively forming a visual narrative. The final unfolding reveals the full set of completed images along with a message in text that summarizes the narrative conveyed by the sequence of images. Initially, the recipient experiences each progressing image individually, with one new image revealed per unfolding. Once the greeting card is fully unfolded, all progressing images are simultaneously visible in a layout that can be retained for display, such as by framing, mounting on a refrigerator, or similar purposes.

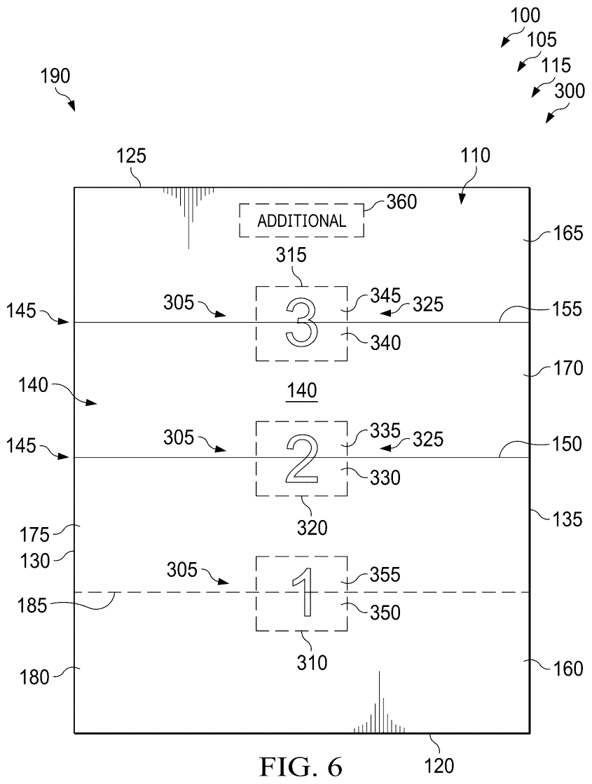

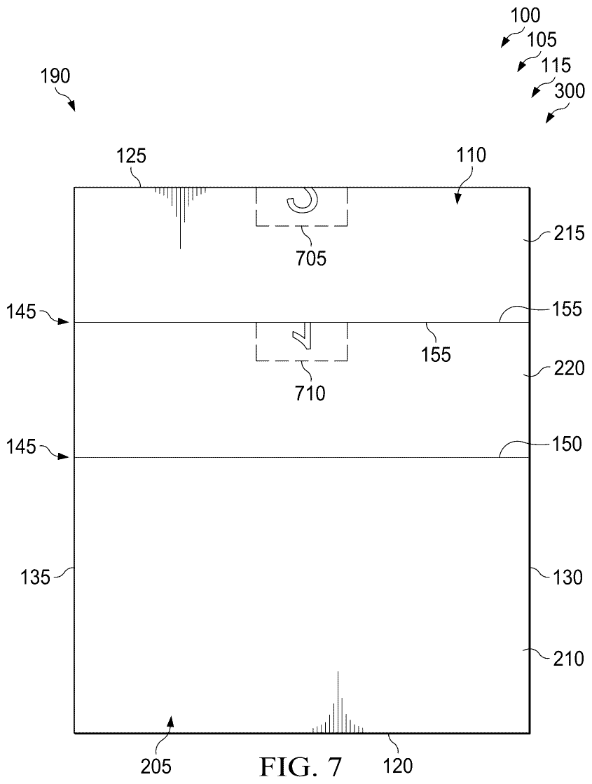

Another example of the progressing images greeting card 100 is illustrated in FIGS. 6 and 7. FIG. 6 is a schematic front view of this example, showing the card stock sheet 115 of the greeting card in an unfolded configuration, in accordance with one or more implementations of the present disclosure. FIG. 7 is a schematic back side view of the greeting card of FIG. 6, also showing the card stock sheet in the unfolded configuration, in accordance with one or more implementations of the present disclosure.

The front side of the card stock sheet 115 in the example illustrated in FIGS. 6 and 7 is similar to the front side of the card stock sheet 115 shown in FIG. 3. However, the back side of the card stock sheet 115, as shown in FIG. 7, includes images that are revealed when the greeting card 100 is folded, as described in further detail below. Specifically, the top back panel 215 includes a top back panel image 705 positioned near the top edge 125 of the card stock sheet 115, and the intermediate back panel 220 includes an intermediate back panel image 710 positioned near the top fold 155. In the example shown in FIG. 7, the top back panel image 705 is a vertically flipped example of the intermediate progressing image top portion 335 shown in FIG. 6, and the intermediate back panel image 710 is a vertically flipped example of the first progressing image top portion 355.

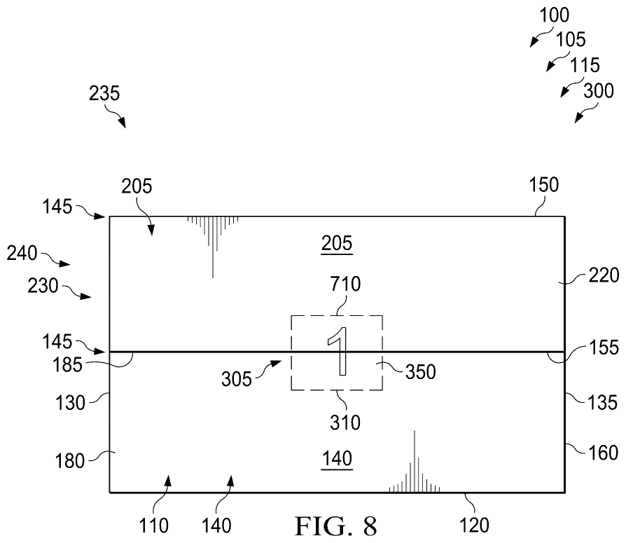

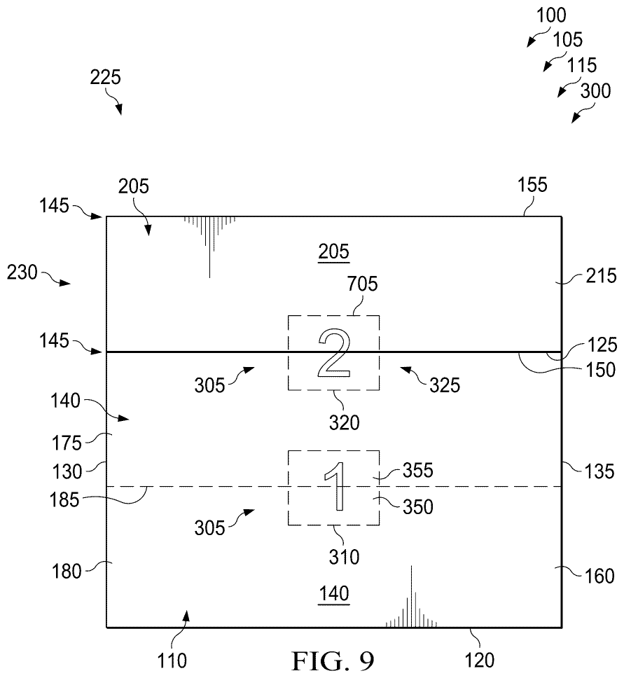

FIGS. 8 and 9 illustrate the operation of the greeting card 100 shown in FIGS. 6 and 7. FIG. 8 is a schematic front view of the greeting card 100 in the final folded configuration 235. In this configuration, the greeting card 100 is initially presented to the recipient. As shown, the top fold 155 forms the first multilayered tab 230, and the bottom fold 150 forms the second multilayered tab 240. As a result, the bottom front panel top portion 180 is covered by the second multilayered tab 240. This tab also conceals the first progressing image top portion 355, such that only the first progressing image bottom portion 350, located on the bottom front panel 160, is visible to the recipient.

However, the intermediate back panel image 710 is positioned to align with and overlay the location of the first progressing image top portion 355. Consequently, when the greeting card 100 is viewed in the final folded configuration 235, the combination of the visible first progressing image bottom portion 350 and the overlaid intermediate back panel image 710 creates a visual impression of the complete first progressing image 310. This presentation encourages the recipient to lift the second multilayered tab 240, thereby unfolding the bottom fold 150 to reveal the undivided first progressing image 310.

FIG. 9 is a schematic front view of the greeting card 100 in the first folded configuration 225, which results after the recipient unfolds the bottom fold 150. In this configuration, the recipient is able to view the complete first progressing image 310 in its unbroken form. The intermediate progressing image bottom portion 330 is also visible, while the intermediate progressing image top portion 335 remains hidden beneath the first multilayered tab 230, which is formed by the top fold 155.

In this example, the top back panel image 705 is positioned to align with and overlay the intermediate progressing image top portion 335. As a result, when the greeting card 100 is viewed in the first folded configuration 225, the combination of the visible intermediate progressing image bottom portion 330 and the overlaid top back panel image 705 provides a visual impression of the complete intermediate progressing image 320. This arrangement invites the recipient to unfold the top fold 155, thereby opening the card into the unfolded configuration shown in FIG. 6, in which the full intermediate progressing image 320 is revealed. Additionally, the final progressing image 315 becomes visible in the unfolded configuration.

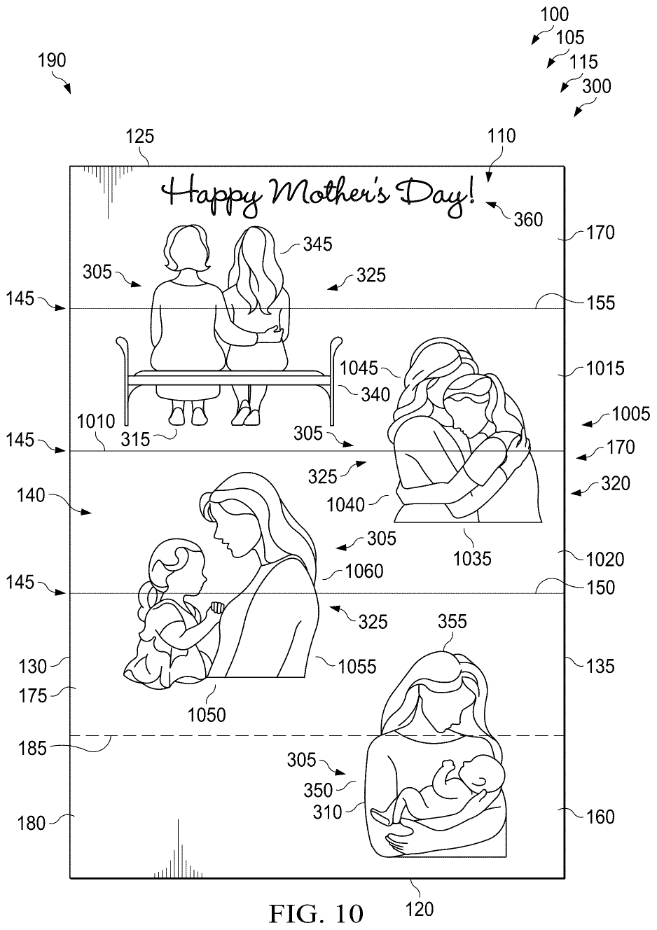

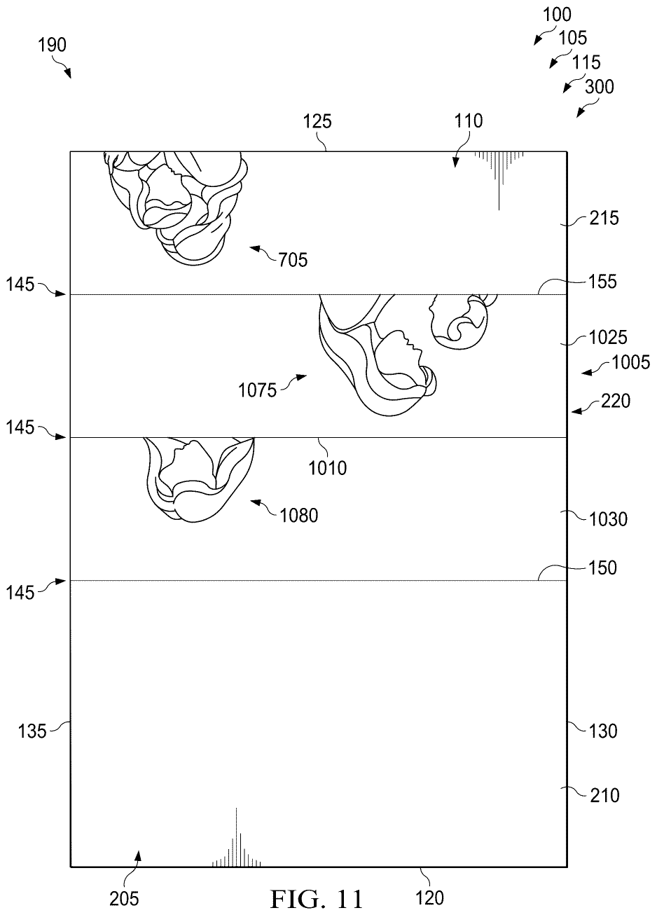

Another example of the progressing images greeting card 100 is illustrated in FIGS. 10 and 11. FIG. 10 shows the front side of the card stock sheet 115, and FIG. 11 shows the back side of the same card stock sheet 115. The front side in this example is similar to the configuration shown in FIG. 6 but includes specific examples of progressing images 305 that may be presented.

In the illustrated example, the greeting card 100 is implemented as a Mother's Day greeting card. The progressing images 305 are timewise progressing images depicting a mother and daughter advancing in age.

Additionally, in the example shown in FIGS. 10 and 11, the intermediate front panel 170 is configured as a multi-panel intermediate front panel 1005, which includes multiple panels separated by one or more intermediate folds 1010. In the shown example, the intermediate front panel 170 includes one intermediate fold 1010, which divides it into a first intermediate front panel 1015 and a second intermediate front panel 1020. Each of these panels has a corresponding back-side panel: a first intermediate rear panel 1025 and a second intermediate rear panel 1030, respectively.

The multi-panel intermediate front panel 1005 includes a first intermediate progressing image 1035, which comprises a first intermediate progressing image bottom portion 1040 and a first intermediate progressing image top portion 1045, and a second intermediate progressing image 1050, which comprises a second intermediate progressing image bottom portion 1055 and a second intermediate progressing image top portion 1060.

The first intermediate rear panel 1025 can include a first intermediate rear panel image 1075 that corresponds to the second intermediate progressing image top portion 1060. Similarly, the second intermediate rear panel 1030 can include a second intermediate rear panel image 1080 that corresponds to the first intermediate progressing image top portion 1045.

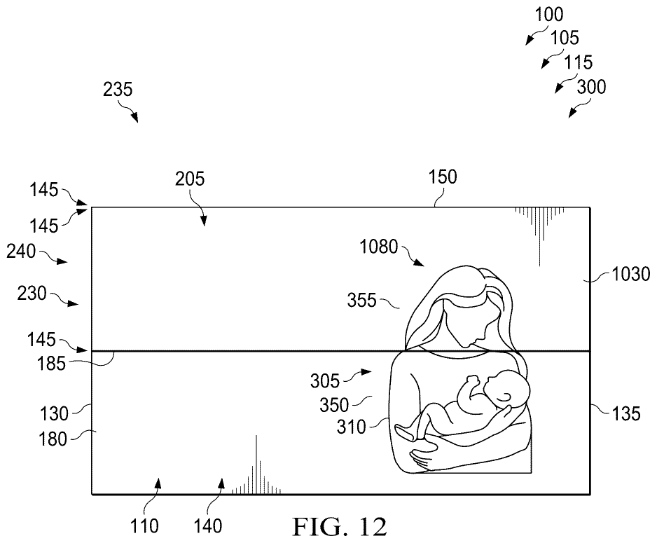

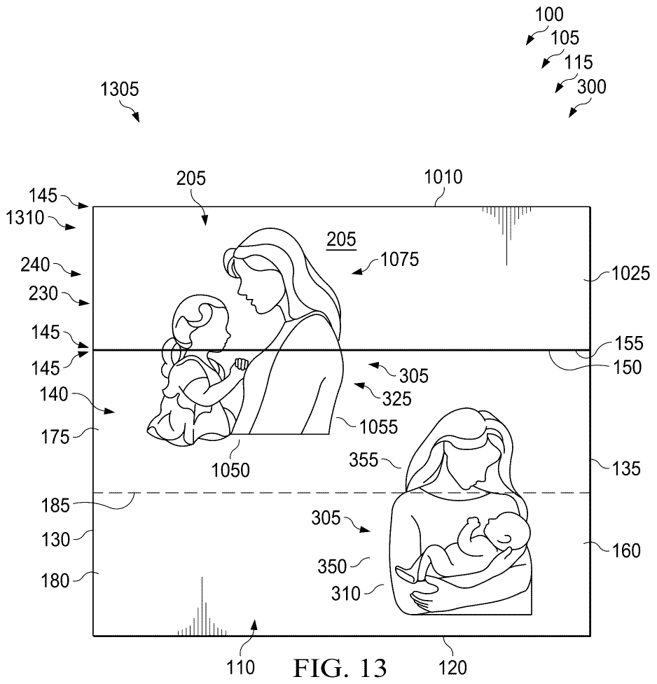

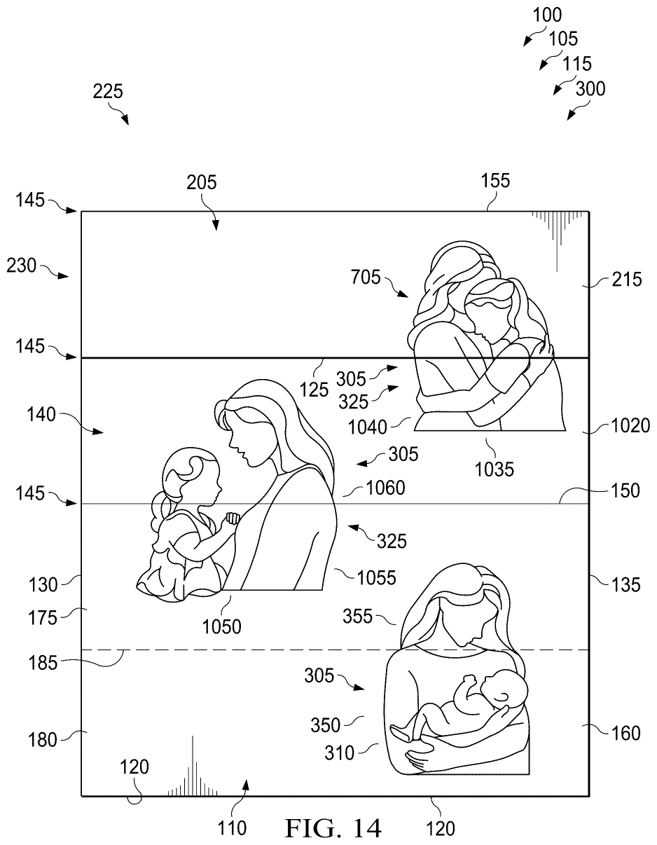

The inclusion of one or more additional intermediate panels enables the presentation of additional progressing images 305 to the recipient, as illustrated in FIGS. 12 through 14. FIG. 12 illustrates a first folded configuration 235, which serves as the final folded configuration and is similar to the configuration depicted in FIG. 8. FIG. 13 shows a second folded configuration 1305, which represents an intermediate folded state and includes an intermediate multilayered tab 1310, as further described herein. FIG. 14 illustrates a third folded configuration 225, which is another intermediate folded configuration and corresponds to the configuration shown in FIG. 9.

The progressing images 305 of the progressing images greeting card 100 can be applied to the card stock sheet 115 using any suitable method. For example, the progressing images 305 can consist of stock photographs or illustrations that are applied—such as by printing—to a standard version of the progressing images greeting card 100. In another example, the progressing images 305 can be customized. A user may upload personal photographs or illustrations to be used as the progressing images. In some implementations, the user can upload images into a design template and print the greeting card 100 onto a card stock sheet 115 independently.

Variations of the greeting card 100 will be apparent to those skilled in the art. For example, the greeting card 100 can incorporate a different number or arrangement of folds, thereby altering the number of images to better correspond with the intended narrative. In addition, rather than using a single fragmented or fold-overlapping image across a fold, the greeting card 100 can include multiple images fragmented across the same fold if such a configuration is better suited to the narrative structure.

The greeting card 100 can also incorporate multiple lines of text, with specific text elements revealed during each unfolding step. Furthermore, in certain implementations, the text itself can be fragmented in a manner similar to the image fragmentation described in other examples.

The greeting card 100 described herein transforms each image from a fragmented state to a complete representation, while concurrently revealing the next image in the progression. This creates a visually engaging and interactive experience for the recipient. The images are not merely revealed—they are dynamically reassembled, adding a visual effect that enhances the presentation beyond that of traditional progressive cards. Rather than being independently stacked, the images are interconnected through the fold structure, enabling a seamless visual transition between successive stages of the narrative.

The fold lines are purposefully integrated into the image layout, making the unfolding process an intentional and visually coherent element of the design. Each unfolding step contributes to a sense of resolution, as a previously fragmented image becomes whole. This progressive transformation reinforces the narrative and heightens the emotional impact for the recipient.

In some implementations, a foldable greeting card (e.g., 300 in FIG. 10) comprises a front panel (e.g., 170 in FIG. 10) and a back panel (e.g., 220 in FIG. 11). The front panel comprises a first portion (e.g. 350 in FIG. 10) and a second portion (e.g., 355 in FIG. 10) of a first image (e.g., 310 in FIG. 10). The back panel comprises a third portion (e.g., 1080 in FIG. 11) of the first image that corresponds to the second portion of the first image. In an unfolded configuration (e.g., the configuration in FIGS. 10 and 11) of the greeting card, the first portion (e.g., 350) and the second portion (e.g., 355) of the first image on the front panel form a first representation of the first image and are visible at a first perspective (e.g., from the viewpoint of a user viewing the greeting card in the configuration shown in FIG. 10), and the third portion (e.g., 1080) of the first image on the back panel is concealed at the first perspective. In a first folded configuration (e.g., the configuration in FIG. 12) of the greeting card, the first portion (e.g., 350) of the first image on the front panel and the third portion (e.g., 1080) of the first image on the back panel form a second representation of the first image and are visible at the first perspective, and the second portion (e.g., 355) of the first image on the front panel is concealed at the first perspective. The first representation of the first image and the second representation of the first image convey a same visual content.

In some implementations, the front panel further comprises a first portion (e.g., 1055 in FIG. 10) and a second portion (e.g., 1060 in FIG. 10) of a second image (e.g., 1050 in FIG. 10), and the back panel comprises a third portion (e.g., 1075 in FIG. 11) of the second image that corresponds to the second portion (e.g., 1060) of the second image. In the unfolded configuration (e.g., the configurations in FIGS. 10 and 11) of the greeting card, the first portion (e.g., 1055) and the second portion (e.g., 1060) of the second image on the front panel form a first representation of the second image and are visible at the first perspective, and the third portion (e.g., 1075) of the second image on the back panel is concealed at the first perspective. In a second folded configuration (e.g., the configuration in FIG. 13) of the greeting card, the first portion (e.g., 1055) of the second image on the front panel and the third potion (e.g., 1075) of the second image on the back panel form a second representation of the second image and are visible at the first perspective, the second portion (e.g., 1060) of the second image on the front panel is concealed at the first perspective, and the first representation of the second image and the second representation of the second image convey a same visual content. In the second folded configuration (e.g., the configuration in FIG. 13) of the greeting card, the first portion (e.g., 350) and the second portion (e.g., 355) of the first image on the front panel form the first representation of the first image and are visible at the first perspective, and the third portion (e.g., 1080) of the first image on the back panel is concealed at the first perspective.

In some implementations, the second portion (e.g., 355) of the first image and third portion (e.g., 1080) of the first image are duplicates of each other, and the second portion (e.g., 1060) of the second image and third portion (e.g., 1075) of the second image are duplicates of each other.

In some implementations, the front panel further comprises a first portion (e.g., 1040 in FIG. 10) and a second portion (e.g., 1045 in FIG. 10) of a third image (e.g., 1035 in FIG. 10). In the unfolded configuration (e.g., the configurations in FIGS. 10 and 11) of the greeting card, the first portion (e.g., 1040) and the second portion (e.g., 1045) of the third image on the front panel form a representation of the third image and are visible at the first perspective. In either the first folded configuration (e.g., the configuration in FIG. 12) or the second folded configuration (e.g., the configuration in FIG. 13), the first portion (e.g., 1040) and the second portion (e.g., 1045) of the third image on the front panel are concealed at the first perspective.

In some implementations, a visible area of the greeting card in the unfolded configuration at the first perspective is larger than a visible area of the greeting card in the second folded configuration at the first perspective, and the visible area of the greeting card in the second folded configuration at the first perspective is larger than a visible area of the greeting card in the first folded configuration at the first perspective.

In some implementations, the first image (e.g., 310), the second image (e.g., 1050), and the third image (e.g., 1035) collectively represent a narrative sequence. In some implementations, the first image, the second image, and the third image are associated with a message, a celebration, or an event.

In some implementations, the foldable greeting card is made of a cardstock, a laminated paper, or a printable plastic.

The disclosure is not limited to greeting cards alone. In another aspect, a foldable printed article is provided, which may include but is not limited to cards, booklets, promotional materials, or other substrates capable of folding. In some implementations, a foldable printed article includes a substrate including a first surface and a second surface, and a visual composition printed on the substrate. The visual composition includes a plurality of image components printed on the first surface and the second surface. The substrate is foldable between an unfolded configuration and a folded configuration. In the unfolded configuration, a first set of the plurality of image components are visible from a viewing perspective and collectively form a first representation of the visual composition, and a second set of the plurality of image components are concealed from the viewing perspective. In the folded configuration, at least a portion of the first set and at least a portion of the second set are visible and collectively form a second representation of the visual composition. The first representation and the second representation convey a same visual content.

In some implementations, the plurality of visual components form a sequential narrative across the unfolded configuration and the folded configuration.

In some implementations, the substrate includes at least one dividing line, and wherein the substrate is foldable along the at least one dividing line.

In some implementations, at least two image components are printed on opposing sides of the at least one dividing line and visually combine to form a continuous image in the unfolded configuration.

In some implementations, at least one image component printed on the first surface and at least one image component printed on the second surface visually align to form a continuous image in the folded configuration.

In some implementations, the substrate includes a paper material or a printable polymer material.

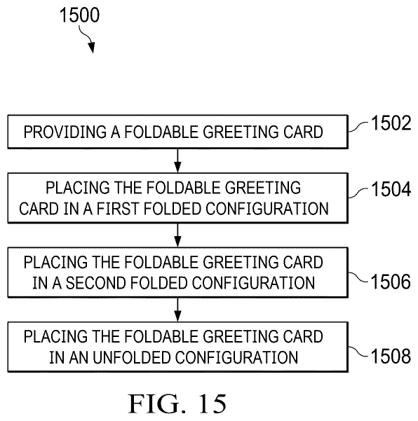

FIG. 15 illustrates an example process 1500 of unfolding a foldable greeting card, according to one or more implementations of the present disclosure.

A foldable greeting card is provided (1502). In some implementations, the foldable greeting card (e.g., 300 in FIG. 10) comprises a front panel (e.g., 170 in FIG. 10) and a back panel (e.g., 220 in FIG. 11). The front panel comprises a first portion (e.g. 350 in FIG. 10) and a second portion (e.g., 355 in FIG. 10) of a first image (e.g., 310 in FIG. 10), and the back panel comprises a third portion (e.g., 1080 in FIG. 11) of the first image that corresponds to the second portion of the first image.

In some implementations, in an unfolded configuration (e.g., the configuration in FIGS. 10 and 11) of the greeting card, the first portion (e.g., 350) and the second portion (e.g., 355) of the first image on the front panel form a first representation of the first image and are visible at a first perspective (e.g., from the viewpoint of a user viewing the greeting card in the configuration shown in FIG. 10), and the third portion (e.g., 1080) of the first image on the back panel is concealed at the first perspective.

The foldable greeting card is placed in a first folded configuration (1504). In some implementations, in the first folded configuration (e.g., the configuration in FIG. 12) of the greeting card, the first portion (e.g., 350) of the first image on the front panel and the third portion (e.g., 1080) of the first image on the back panel form a second representation of the first image and are visible at the first perspective, and the second portion (e.g., 355) of the first image on the front panel is concealed at the first perspective, and the first representation of the first image and the second representation of the first image convey a same visual content.

In some implementations, the front panel further comprises a first portion (e.g., 1055 in FIG. 10) and a second portion (e.g., 1060 in FIG. 10) of a second image (e.g., 1050 in FIG. 10), and the back panel comprises a third portion (e.g., 1075 in FIG. 11) of the second image that corresponds to the second portion (e.g., 1060) of the second image.

The foldable greeting card is placed in a second folded configuration (1506). In some implementations, in the second folded configuration (e.g., the configuration in FIG. 13) of the greeting card, the first portion (e.g., 1055) of the second image on the front panel and the third potion (e.g., 1075) of the second image on the back panel form a second representation of the second image and are visible at the first perspective, the second portion (e.g., 1060) of the second image on the front panel is concealed at the first perspective, and the first representation of the second image and the second representation of the second image convey a same visual content.

In some implementations, in the second folded configuration of the greeting card, the first portion (e.g., 350) and the second portion (e.g., 355) of the first image on the front panel form the first representation of the first image and are visible at the first perspective, and the third portion (e.g., 1080) of the first image on the back panel is concealed at the first perspective.

In some implementations, the second portion (e.g., 355) of the first image and third portion (e.g., 1080) of the first image are duplicates of each other, and the second portion (e.g., 1060) of the second image and third portion (e.g., 1075) of the second image are duplicates of each other.

In some implementations, the front panel further comprises a first portion (e.g., 1040 in FIG. 10) and a second portion (e.g., 1045 in FIG. 10) of a third image (e.g., 1035 in FIG. 10).

The foldable greeting card is placed in the unfolded configuration (1508). In some implementations, one or more additional steps may be performed between steps 1506 and 1508, depending on the specific configuration of the foldable greeting card—for example, based on the number of folds present in the greeting card.

In some implementations, in the unfolded configuration (e.g., the configurations in FIGS. 10 and 11) of the greeting card, the first portion (e.g., 1040) and the second portion (e.g., 1045) of the third image on the front panel form a representation of the third image and are visible at the first perspective. In some implementations, in either the first folded configuration (e.g., the configuration in FIG. 12) or the second folded configuration (e.g., the configuration in FIG. 13), the first portion (e.g., 1040) and the second portion (e.g., 1045) of the third image on the front panel are concealed at the first perspective.

In some implementations, the foldable greeting card are placed in the first folded configuration, the second folded configuration, and the unfolded configuration in a sequential manner.

In some implementations, the first image (e.g., 310), the second image (e.g., 310), and the third image (e.g., 1035) collectively represent a narrative sequence.

While this document may describe many specifics, these should not be construed as limitations on the scope of an invention that is claimed or of what may be claimed, but rather as descriptions of features specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A foldable greeting card, comprising:
a front panel; and
a back panel,
wherein the front panel comprises a first portion and a second portion of a first image, and wherein the back panel comprises a third portion of the first image that corresponds to the second portion of the first image,
wherein in an unfolded configuration of the greeting card, the first portion and the second portion of the first image on the front panel form a first representation of the first image and are visible at a first perspective, and the third portion of the first image on the back panel is concealed at the first perspective,
wherein in a first folded configuration of the greeting card, the first portion of the first image on the front panel and the third portion of the first image on the back panel form a second representation of the first image and are visible at the first perspective, and the second portion of the first image on the front panel is concealed at the first perspective, and
wherein the first representation of the first image and the second representation of the first image convey a same visual content.

2. The foldable greeting card according to claim 1, wherein the front panel further comprises a first portion and a second portion of a second image, and wherein the back panel comprises a third portion of the second image that corresponds to the second portion of the second image,
wherein in the unfolded configuration of the greeting card, the first portion and the second portion of the second image on the front panel form a first representation of the second image and are visible at the first perspective, and the third portion of the second image on the back panel is concealed at the first perspective, and
wherein in a second folded configuration of the greeting card, the first portion of the second image on the front panel and the third potion of the second image on the back panel form a second representation of the second image and are visible at the first perspective, the second portion of the second image on the front panel is concealed at the first perspective, and the first representation of the second image and the second representation of the second image convey a same visual content, and
wherein in the second folded configuration of the greeting card, the first portion and the second portion of the first image on the front panel form the first representation of the first image and are visible at the first perspective, and the third portion of the first image on the back panel is concealed at the first perspective.

3. The foldable greeting card according to claim 2, wherein the second portion of the first image and third portion of the first image are duplicates of each other, and the second portion of the second image and third portion of the second image are duplicates of each other.

4. The foldable greeting card according to claim 2, wherein the front panel further comprises a first portion and a second portion of a third image,
wherein in the unfolded configuration of the greeting card, the first portion and the second portion of the third image on the front panel form a representation of the third image and are visible at the first perspective, and
wherein in either the first folded configuration or the second folded configuration, the first portion and the second portion of the third image on the front panel are concealed at the first perspective.

5. The foldable greeting card according to claim 4, wherein a visible area of the greeting card in the unfolded configuration at the first perspective is larger than a visible area of the greeting card in the second folded configuration at the first perspective, and the visible area of the greeting card in the second folded configuration at the first perspective is larger than a visible area of the greeting card in the first folded configuration at the first perspective.

6. The foldable greeting card according to claim 4, wherein the first image, the second image, and the third image collectively represent a narrative sequence.

7. The foldable greeting card according to claim 4, wherein the first image, the second image, and the third image are associated with a message, a celebration, or an event.

8. The foldable greeting card according to claim 1, wherein the foldable greeting card is made of a cardstock, a laminated paper, or a printable plastic.

9. A foldable greeting card, comprising:
a front panel; and
a back panel,
wherein the front panel comprises a first portion and a second portion of a first image, and wherein the back panel comprises a third portion of the first image that corresponds to the second portion of the first image,
wherein in an unfolded configuration of the greeting card, the first portion and the second portion of the first image on the front panel form a first representation of the first image and are visible at a first perspective, and the third portion of the first image on the back panel is concealed at the first perspective,
wherein in a first folded configuration of the greeting card, the first portion of the first image on the front panel and the third portion of the first image on the back panel form a second representation of the first image and are visible at the first perspective, and the second portion of the first image on the front panel is concealed at the first perspective, and wherein the first representation of the first image and the second representation of the first image convey a same visual content,
wherein the front panel further comprises a first portion and a second portion of a second image, and wherein the back panel comprises a third portion of the second image that corresponds to the second portion of the second image,
wherein in the unfolded configuration of the greeting card, the first portion and the second portion of the second image on the front panel form a first representation of the second image and are visible at the first perspective, and the third portion of the second image on the back panel is concealed at the first perspective, and
wherein in a second folded configuration of the greeting card, the first portion of the second image on the front panel and the third potion of the second image on the back panel form a second representation of the second image and are visible at the first perspective, the second portion of the second image on the front panel is concealed at the first perspective, and the first representation of the second image and the second representation of the second image convey a same visual content, and
wherein in the second folded configuration of the greeting card, the first portion and the second portion of the first image on the front panel form the first representation of the first image and are visible at the first perspective, and the third portion of the first image on the back panel is concealed at the first perspective,
wherein the front panel further comprises a first portion and a second portion of a third image,
wherein in the unfolded configuration of the greeting card, the first portion and the second portion of the third image on the front panel form a representation of the third image and are visible at the first perspective, and
wherein in either the first folded configuration or the second folded configuration, the first portion and the second portion of the third image on the front panel are concealed at the first perspective.

10. The foldable greeting card according to claim 9, wherein the second portion of the first image and third portion of the first image are duplicates of each other, and the second portion of the second image and third portion of the second image are duplicates of each other.

11. The foldable greeting card according to claim 9, wherein a visible area of the greeting card in the unfolded configuration at the first perspective is larger than a visible area of the greeting card in the second folded configuration at the first perspective, and the visible area of the greeting card in the second folded configuration at the first perspective is larger than a visible area of the greeting card in the first folded configuration at the first perspective.

12. The foldable greeting card according to claim 9, wherein the first image, the second image, and the third image collectively represent a narrative sequence.

13. The foldable greeting card according to claim 9, wherein the first image, the second image, and the third image are associated with a message, a celebration, or an event.

14. The foldable greeting card according to claim 9, wherein the foldable greeting card is made of a cardstock, a laminated paper, or a printable plastic.

15. A foldable printed article, comprising:
a substrate comprising a first surface and a second surface; and
a visual composition printed on the substrate, wherein the visual composition comprises a plurality of image components printed on the first surface and the second surface,
wherein the substrate is foldable between an unfolded configuration and a folded configuration,
wherein in the unfolded configuration, a first set of the plurality of image components are visible from a viewing perspective and collectively form a first representation of the visual composition, and a second set of the plurality of image components are concealed from the viewing perspective,
wherein in the folded configuration, at least a portion of the first set and at least a portion of the second set are visible and collectively form a second representation of the visual composition, and
wherein the first representation and the second representation convey a same visual content.

16. The foldable printed article according to claim 15, wherein the plurality of visual components form a sequential narrative across the unfolded configuration and the folded configuration.

17. The foldable printed article according to claim 15, wherein the substrate comprises at least one dividing line, and wherein the substrate is foldable along the at least one dividing line.

18. The foldable printed article according to claim 17, wherein at least two image components are printed on opposing sides of the at least one dividing line and visually combine to form a continuous image in the unfolded configuration.

19. The foldable printed article according to claim 15, wherein at least one image component printed on the first surface and at least one image component printed on the second surface visually align to form a continuous image in the folded configuration.

20. The foldable printed article according to claim 15, wherein the substrate comprises a paper material or a printable polymer material.
